(19) United States
(12) Patent Application Publication
(10) Pub. No.: US 2021/0140208 A1
(43) Pub. Date: May 13, 2021

(54) FASTENING STRUCTURE

(71) Applicant: PEGATRON CORPORATION, TAIPEI CITY (TW)

(72) Inventors: Ching-Yen Huang, Taipei City (TW); Hui-Chen Wang, Taipei City (TW); Yi-Chun Tang, Taipei City (TW); Hung-Yun Wu, Taipei City (TW); Hsiao-Fan Chen, Taipei City (TW)

(73) Assignee: PEGATRON CORPORATION, TAIPEI CITY (TW)

(21) Appl. No.: 17/027,413

(22) Filed: Sep. 21, 2020

(30) Foreign Application Priority Data
Nov. 13, 2019 (TW) 108141206

(51) Int. Cl. E05C 3/00; E05C 3/12

(52) U.S. Cl. CPC E05C 3/008; E05Y 2900/606; E05Y 2201/474; E05C 3/12

(57) ABSTRACT

A fastening structure includes a first casing, an ejection mechanism, a second casing, and a switch mechanism disposed at the second casing. The first casing has a slot where the ejection mechanism is disposed in. The switch mechanism includes a switch component pivotally connected to the second casing along a first axis, a first spring connected to the second casing and switch component, and a hook pivotally connected to the switch component along a second axis. When the hook rotates towards the first casing around the second axis, the hook drives the switch component to move to stretch the first spring, so the hook is engaged with the slot and presses against the ejection mechanism. When the switch component rotates with respect to the second casing, the switch component drives the hook to be separated from the slot, and the ejection mechanism pushes the hook out of the first casing.

### CROSS-REFERENCE TO RELATED APPLICATION

This application claims the priority benefit of Taiwan application serial no. 108141206, filed on Nov. 13, 2019. The entirety of the above-mentioned patent application is hereby incorporated by reference herein and made a part of this specification.

### BACKGROUND

### Technical Field

The disclosure relates to a fastening structure, and more particularly, relates to a switch design of a fastening structure.

### Description of Related Art

In a common two-piece casing structure, an upper casing and a lower casing are included. The upper casing is provided with a slot, and the lower casing is engaged with the slot through an engaging mechanism, such that the relative position between the upper casing and the lower casing is fixed. In contrast, after the engaging relationship between the engaging mechanism and the slot is lifted, the upper casing and the lower casing are capable of moving relative to each other.

In a general engaging mechanism, a two-stage operational design is adopted. The engaging mechanism includes a switch component and a hook. The switch component is pivotally connected to the lower casing, and the hook is pivotally connected to the switch component. The hook is configured to be engaged with the slot of the upper casing. If a user intends to release the engaging relationship between the engaging mechanism and the slot, the user needs to pull up the switch component first to drive the hook to be slightly lifted in the slot. Next, the user has to manually pull the hook out of the slot, so as to complete the step of releasing the engaging relationship between the engaging mechanism and the slot. In contrast, if the user intends to reset the engaging relationship between the engaging mechanism and the slot, the user has to pull the hook first and then moves the hook into the slot. Next, the user has to pull down the switch component to set the hook to be engaged with the slot, so as to complete the step of resetting the engaging relationship between the engaging mechanism and the slot.

The above operational steps are excessively complicated and are not convenient for users.

### SUMMARY

The disclosure provides a fastening structure exhibiting operational convenience.

A fastening structure provided by an embodiment of the disclosure includes a first casing, an ejection mechanism, a second casing, and a switch mechanism. The first casing has a slot. The ejection mechanism is disposed in the slot. The second casing is opposite to the first casing. The switch mechanism is disposed at the second casing. The switch mechanism includes a switch component, a first spring, and a hook. The switch component is pivotally connected to the second casing along a first axis. The first spring is connected to the second casing and the switch component. The hook is pivotally connected to the switch component along a second axis parallel to the first axis. When the hook rotates towards the first casing around the second axis, the hook drives the switch component to move to stretch the first spring, so that the hook is engaged with the slot and presses against the ejection mechanism. When the switch component rotates with respect to the second casing, the switch component drives the hook to be separated from the slot, and the ejection mechanism pushes the hook out of the first casing.

To sum up, in the fastening structure provided by the disclosure, when the user pulls the switch component so that the hook is separated from the slot, the ejection mechanism may automatically push the hook out of the slot. In contrast, when the user pulls the hook and moves the hook into the slot, the first spring may drive the hook through the switch component, so that the hook is automatically engaged with the slot. Therefore, the fastening structure provided by the disclosure may provide the user with operational convenience.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of a fastening structure according to an embodiment of the disclosure.

FIG. 2 is schematic local enlargement view of the fastening structure of FIG. 1 in a first mode.

FIG. 3 is a schematic local enlargement view of FIG. 2 from another viewing angle.

FIG. 4 is a local cross-sectional view of FIG. 2.

FIG. 5 is schematic local enlargement view of the fastening structure of FIG. 1 in a second mode.

### DESCRIPTION OF THE EMBODIMENTS

FIG. 1 is a schematic view of a fastening structure according to an embodiment of the disclosure. FIG. 2 is schematic local enlargement view of the fastening structure of FIG. 1 in a first mode. FIG. 3 is a schematic local enlargement view of FIG. 2 from another viewing angle. FIG. 4 is a schematic local cross-sectional view of FIG. 2. Note that in order to clearly present an internal structure, a portion of a second casing 130 in FIG. 3 is omitted. With reference to FIG. 1 to FIG. 4, in this embodiment, a fastening structure 100 may be applied to an electronic apparatus, such as a rugged computer, a notebook computer, a server chassis, a computer case, or other suitable apparatuses.

To be specific, the fastening structure 100 includes a first casing 110, an ejection mechanism 120, a second casing 130 opposite to the first casing 110, and a switch mechanism 140. In the first mode, the switch mechanism 140 is in an off state, a relative position between the first casing 110 and the second casing 130 is fixed, and the first casing 110 covers the second casing 130.

The first casing 110 has a slot 111, and the ejection mechanism 120 is disposed in the slot 111. The switch mechanism 140 is disposed at the second casing 130 and is configured to fix the first casing 110 onto the second casing 130 or to separate the first casing 110 from the second casing 130. To be specific, the switch mechanism 140 includes a switch component 141, a first spring 142, and a hook 143. The switch component 141 is pivotally connected to the second casing 130 along a first axis A1, and the first spring 142 is connected between the second casing 130 and the switch component 141. The first spring 142 may be a tensile spring. A number of the first spring 142 may be two, and the two first springs 142 are arranged side by side.

The hook 143 is pivotally connected to the switch component 141 along a second axis A2 parallel to the first axis A1, and the first axis A1 and the second axis A2 are not coaxial. In the first mode, the hook 143 rotates towards the first casing 110 around the second axis A2 and drives the switch component 141 to move to stretch the two first springs 142. Moreover, elastic restoring forces of the two first springs 142 act on the switch component 141, so that the switch component 141 keeps rotating in a rotation direction R. At the same time, the switch component 141 provides a downward force to the hook 143, so that the hook 143 is engaged with the slot 111 and presses against the ejection mechanism 120.

Before the hook 143 is engaged with the slot 111, when a user pulls the hook 143 and moves the hook 143 into the slot 111, the switch component 141 rotates in an opposite direction of the rotation direction R, so that the two first springs 142 are stretched. The elastic restoring forces of the two stretched first springs 142 may drive the hook 143 to move through the switch component 141, so that the hook 143 is automatically engaged with the slot 111. Therefore, the user does not have to manually pull the switch component 141 to set the hook 143 to be engaged with the slot 111.

In this embodiment, the ejection mechanism 120 includes a second spring 121 and an ejection plate 122, and two ends of the second spring 121 are respectively connected to the first casing 110 and the ejection plate 122. The second spring 121 may be a compression spring. A number of the second spring 121 may be two, and the two second springs 121 are arranged side by side in the slot 111. In the first mode, the hook 143 presses against the ejection plate 122, and the two second springs 121 are compressed.

With reference to FIG. 3 and FIG. 4 together, on an Z axis, height differences are provided among the first axis A1, the second axis A2, and any one of the first springs 142, and the first axis A1 is located between the second axis A2 and any one of the first springs 142. Further, the switch component 141 includes a top portion 141a close to the first casing 110 and a bottom portion 141b away from the first casing 110. The hook 143 is pivotally connected to the top portion 141a, and each of the first springs 142 is connected to the bottom portion 141b. Further, the position where the first axis A1 extends through the switch component 141 approximately falls between the top portion 141a and the bottom portion 141b. Therefore, the elastic restoring forces of the two first springs 142 may act on the switch component 141, so that the switch component 141 rotates with respect to the second casing 130 around the first axis A1 and drives the hook 143 to move.

In this embodiment, the second casing 130 has a recess 131 configured to accommodate a portion of the switch mechanism 140. To be specific, a portion of the hook 143 and the switch component 141 are located in the recess 131. The first axis A1 and the second axis A2 extend and go through the recess 131, and portions of the first springs 142 extend to the recess 131 to be connected to the switch component 141.

The recess 131 has a bottom surface 131a and two side surfaces 131b connected to the bottom surface 131a, and the two side surfaces 131b are arranged at two sides of the bottom surface 131a side by side. Further, the second casing 130 further includes a first through groove 132 and two second through grooves 133. A number of the first through groove 132 may be two, and the two first through grooves 132 are arranged side by side on the bottom surface 131a. The two first springs 142 respectively pass through the two first through grooves 132. One end of each first spring 142 is located in the second casing 130. Moreover, a middle segment of each first spring 142 passes through the corresponding first through groove 132, so that the other end of each first spring 142 extends into the recess 131 to be connected to the switch component 141.

Note that the number of the first springs, the number of the first through grooves, and the number of the second springs are not particularly limited in the disclosure, and since the first through grooves are configured to accommodate portions of the first springs, the number of the first through grooves and the number of the first springs are equal.

With reference to FIG. 2 to FIG. 4, in this embodiment, the two second through grooves 133 are respectively located at the two side surfaces 131b, and the switch mechanism 140 further includes a first axis shaft 144 extending along the first axis A1 and a second axis shaft 145 extending along the second axis A2. The switch component 141 is pivotally connected to the second casing 130 through the first axis shaft 144, and the hook 143 is pivotally connected to the switch component 141 through the second axis shaft 145. A middle segment of the first axis shaft 144 passes through the switch component 141 and is located in the recess 131.

The switch mechanism 140 further includes two positioning bases 146 installed in the second casing 130, and the two positioning bases 146 respectively correspond to the two second through grooves 133. For instance, the two positioning bases 146 may be fixed inside the second casing 130 through locking, engaging, adhering, or other suitable installation manners. Two ends of the first axis shaft 144 are respectively inserted into the two second through grooves 133 and are respectively inserted into the two positioning bases 146. That is, the two positioning bases 146 are located on the first axis A1, are configured to carry the first axis shaft 144, and serve as rotation pivots of the switch component 141. On the other hand, the second axis shaft 145 is located in the recess 131, a middle segment of the second axis shaft 145 passes through the switch component 141, and two ends of the second axis shaft 145 are inserted into the hook 143.

FIG. 5 is schematic local enlargement view of the fastening structure of FIG. 1 in a second mode. With reference to FIG. 2, FIG. 3, and FIG. 5, in this embodiment, the switch component 141 further includes an extension portion 141c, and the extension portion 141c protrudes from the bottom portion 141b to facilitate pulling of the switch component 141 for the user. When the user pulls the switch component 141 so that the switch component 141 rotates with respect to the second casing 130 in the opposite direction of the rotation direction R, the switch component 141 drives the hook 143 to move to be separated from the slot 111. At this time, elastic restoring forces of the two compressed second springs 121 push the ejection plate 122, and the hook 143 is automatically pushed outside the first casing 110 by the ejection plate 122. Therefore, the user does not have to manually pull the hook 143 out of the slot 111.

In the second mode, the switch mechanism 140 is in an on state, and the first casing 110 and the second casing 130 are capable of moving relative to each other.

In view of the foregoing, in the fastening structure provided by the disclosure, when the user pulls the switch component so that the hook is separated from the slot, the elastic restoring force of the compressed ejection mechanism may automatically push the hook out of the slot. In contrast, when the user pulls the hook and moves the hook into the slot, the elastic restoring forces of the stretched first springs may drive the hook through the switch component, so that the hook is automatically engaged with the slot. Therefore, the fastening structure provided by the disclosure may provide the user with operational convenience.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A fastening structure, comprising:
a first casing, having a slot;
an ejection mechanism, disposed in the slot;
a second casing, opposite to the first casing; and
a switch mechanism, disposed at the second casing, the switch mechanism comprising:
a switch component, pivotally connected to the second casing along a first axis; and
a first spring, connected to the second casing and the switch component; and
a hook, pivotally connected to the switch component along a second axis parallel to the first axis, wherein when the hook rotates towards the first casing around the second axis, the hook drives the switch component to move to stretch the first spring, so that the hook is engaged with the slot and presses against the ejection mechanism, and when the switch component rotates with respect to the second casing, the switch component drives the hook to move to be separated from the slot and the ejection mechanism pushes the hook out of the first casing.

2. The fastening structure according to claim 1, wherein the ejection mechanism comprises a second spring and an ejection plate, the second spring is connected between the first casing and the ejection plate, and when the hook is located in the slot, the hook presses against the ejection plate.

3. The fastening structure according to claim 1, wherein the switch component comprises a top portion close to the first casing and a bottom portion away from the first casing, the hook is pivotally connected to the top portion, and the first spring is connected to the bottom portion.

4. The fastening structure according to claim 3, wherein the switch component further comprises an extension portion protruding from the bottom portion.

5. The fastening structure according to claim 1, wherein when the hook is engaged with the slot, the first casing is closed on the second casing, and when the switch mechanism pushes the hook out of the first casing, the first casing and the second casing are capable of moving relative to each other.

6. The fastening structure according to claim 1, wherein the second casing has a recess, and a portion of the hook and the switch component are located in the recess.

7. The fastening structure according to claim 6, wherein the recess has a bottom surface, the second casing further comprises a first through groove located at the bottom surface, and the first spring passes through the first through groove.

8. The fastening structure according to claim 7, wherein the recess further comprises two side surfaces connected to the bottom surface, the second casing further comprises two second through grooves, and the two second through grooves are located on the two side surfaces respectively,
the switch mechanism further comprises a first axis shaft extending along the first axis, wherein the switch component is pivotally connected to the second casing through the first axis shaft, and two ends of the first axis shaft are respectively inserted into the two second through grooves.

9. The fastening structure according to claim 8, wherein the switch mechanism further comprises two positioning bases installed in the second casing, the two positioning bases respectively correspond to the two second through grooves, and the two ends of the first axis shaft are respectively inserted into the two positioning bases.

10. The fastening structure according to claim 1, wherein the switch mechanism further comprises a second axis shaft extending along the second axis, the hook is pivotally connected to the switch component through the second axis shaft, the second axis shaft passes through the switch component, and two ends of the second axis shaft are inserted into the hook.
